(19) United States
(12) Patent Application Publication
(10) Pub. No.: US 2006/0133415 A1
(43) Pub. Date: Jun. 22, 2006

(54) Wireless internetwork transfer apparatus, systems, and methods

(76) Inventor: Peter D. Mueller, Fair Oaks, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/018,542

(22) Filed: Dec. 21, 2004

(51) Int. Cl. H04Q 7/24

(52) U.S. Cl. 370/466; 370/401

(57) ABSTRACT

Apparatus and systems, as well as methods and articles, may operate to communicate a data packet between at least two wireless networks across a peer-to-peer link.

### TECHNICAL FIELD

Various embodiments described herein relate to electronic communications generally, including apparatus, systems, and methods used to transmit and receive information via wireless networks.

### BACKGROUND INFORMATION

Wireless networks may utilize digital communication techniques and may encode voice, data, or both. As wireless communication becomes increasingly pervasive, coverage areas associated with different networks may overlap at a geographical point of operation of a wireless mobile device. In some cases, a particular network may not be available to the device, even though coverage from the network extends to the device. For example, the network and device may utilize incompatible physical-layer techniques, including modulation, symbol encoding, and media access control (MAC) formats. The network may also be unavailable to the wireless device if the device is not subscribed to the network.

### BRIEF DESCRIPTION OF THE DRAWINGS

FIG. 1 is a block diagram of an apparatus and a system according to various embodiments of the invention.

FIG. 2 is a flow diagram illustrating several methods according to various embodiments of the invention.

FIG. 3 is a block diagram of an article according to various embodiments of the invention.

### DETAILED DESCRIPTION

As noted previously, coverage areas associated with diverse wireless networks may overlap. Some wireless mobile devices may be compatible with two or more such networks of like or different physical layers. Some embodiments disclosed herein may operate to effectuate communication between the two or more wireless networks, may enable access to a wireless network otherwise inaccessible to a mobile device, and/or may operate to decrease resource utilization associated with a mobile device processor.

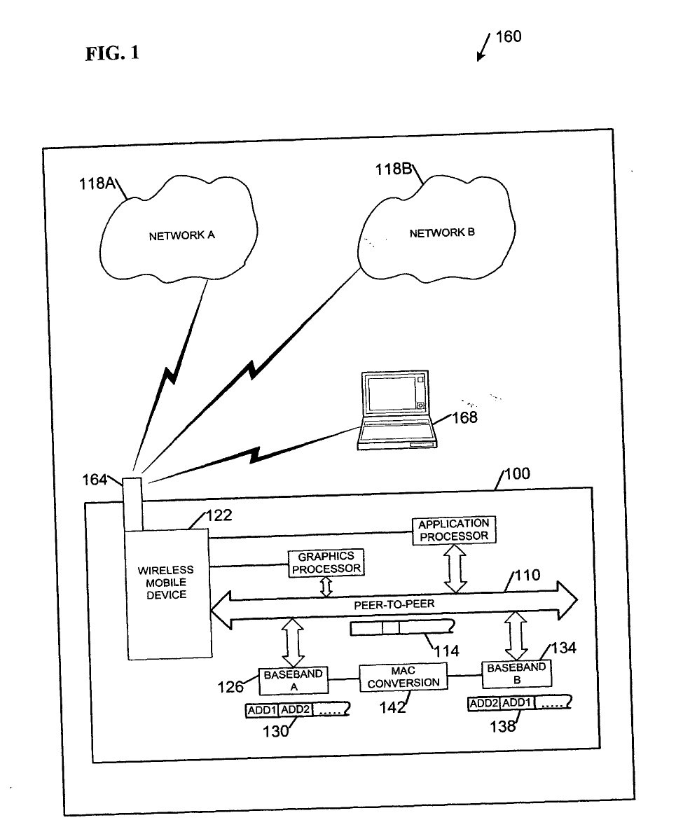

FIG. 1 comprises a block diagram of an apparatus 100 and a system 160 according to various embodiments of the invention. The apparatus 100 may include a peer-to-peer link 110, perhaps comprising a peer-to-peer multi-drop bus, to communicate one or more data packets 114 between wireless networks 118A, 118B. A multidrop bus may comprise a bus that supports two or more devices connected to the same physical interconnect. In some embodiments of the apparatus 100, the peer-to-peer link 110 may comprise two or more distinct buses, possibly connected through a hub or a switch. The peer-to-peer link may include a buffer, and may be capable of substantially simultaneous access by two or more devices.

The wireless networks 118A, 118B may comprises an Institute of Electrical and Electronic Engineers (IEEE) 802.11 network, a general packet radio service (GPRS) network, and/or a wideband code-division multiple-access (WCDMA) network. For further information regarding 802.11 and WCDMA standards, please consult “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments; and “CDMA 2000 Series, Release A (2000)” and related documents, available from the Telecommunications Industry Association (TIA) Internet website at a URL that includes “tiaonline.org/standards/search.cfm?keyword=IS+2000*”, respectively. Information regarding GSM (Global System for Mobile Communications) and GPRS is currently available from the Internet at a URL that includes “gsmworld.com/index.shtml” (GSM Association) and from a URL that includes “gsmworld.com/documents/ireg/ir40310.pdf” (GSM Association document PRD IR-40, “Guidelines for IP4 Addressing and AS Numbering for GPRS Network Infrastructure and Mobile Terminals, Version 3.1.0: 2001).

The apparatus 100 may also include a wireless mobile device 122 (e.g., a hand-held computer, a laptop computer, a personal digital assistant, a cellular telephone, or a device combining capabilities associated with the foregoing devices) to connect to the peer-to-peer link 110 to communicate with the wireless networks 118A, 118B. The peer-to-peer link 110 may be incorporated within the wireless mobile device 122, or may exist external to the device 122 and be coupled thereto via a wired or wireless connection, for example.

The apparatus 100 may further include a first baseband processing module 126 associated with a first MAC format 130 to communicate with a first wireless network 118A, and/or a second baseband processing module 134 associated with a second MAC format 138 to communicate with a second wireless network 118B. The term “baseband,” in the present context, may include one or more received packets resulting from wireless networking demodulation and/or decoding operations, and may include one or more packets in a pre-transmitted format, unencoded and unmodulated. The first MAC format 130 may be different from or substantially identical to the second MAC format 138. The apparatus 100 may also include a MAC conversion module 142 coupled to the first baseband processing module 126 and/or to the second baseband processing module 134 to convert the first MAC format 130 to the second MAC format 138, and vice-versa. Other embodiments may be realized.

For example, a system 160 may include an apparatus 100, comprising a first wireless mobile device 122 to connect to a peer-to-peer link 110 to communicate with one or more wireless networks 118A, 118B, as well as an antenna 164 (e.g., an omnidirectional antenna, a patch antenna, a dipole antenna, among others) coupled to the first wireless mobile device 122.

The system 160 may also include a second wireless mobile device 168 to connect to the first wireless mobile device 122, to communicate with the wireless networks 118A, 118B across the peer-to-peer link 110. However, in some circumstances, the network 118A may be unavailable to, or not directly accessible by, the second wireless mobile device 168. Various embodiments of the apparatus 100 and system 160 may operate to overcome such difficulties.

For example, assume the device 168 comprises an IEEE 802.11-enabled laptop computer without cellular networking capability, and that a user wishes to connect the laptop computer to the network 118A, perhaps because no IEEE 802.11 hotspot is available to connect to the Internet. (An IEEE 802.11 hotspot may include a geographical area in which IEEE 802.11-compatible transmissions may be received from an IEEE 802.11-compatible network). Assume further that the network 118A comprises a data-enabled cellular network (e.g., a GPRS network) with access to the Internet. Finally, assume that the IEEE 802.11-enabled laptop computer is within an IEEE 802.11 operating range of the first wireless device 122, and that device 122 supports both IEEE 802.11 and cellular operation (perhaps an IEEE 802.11-enabled cellular telephone, for example). Although unable to connect directly to the network 118A, the laptop computer may be able to connect to the device 122 and thus, to transmit packets across the peer-to-peer link 110 to the network 118A (the cellular network, in this example). Thus, some embodiments of the apparatus 100 and system 160 may permit the IEEE 802.11-enabled laptop computer to communicate with the Internet at a time when the Internet (or some other wireless network) is not directly available via connection to an IEEE 802.11 hotspot.

The apparatus 100; peer-to-peer link 110; data packets 114; wireless networks 118A, 118B; wireless mobile devices 122, 168; baseband processing modules 126, 134; media access control (MAC) formats 130, 138; MAC conversion module 142; system 160; and antenna 164 may all be characterized as “modules” herein.

Such modules may include hardware circuitry, single and/or multi-processor circuits, memory circuits, software program modules and objects, and/or firmware and combinations thereof, as desired by the architect of the apparatus 100 and system 160 and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, a signal transmission-reception simulation package, and/or a combination of software and hardware used to simulate the operation of various potential embodiments.

It should also be understood that the apparatus and systems of various embodiments can be used in applications other than wireless internetwork transfer procedures, and thus, various embodiments are not to be so limited. The illustrations of apparatus 100 and systems 160 are intended to provide a general understanding of the structure of various embodiments, and are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single and/or multi-processor modules, single and/or multiple embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments may include a number of methods.

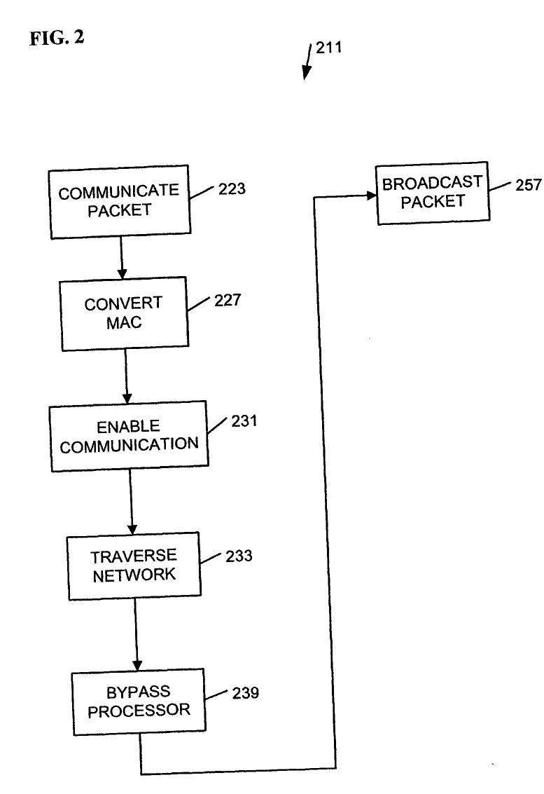

FIG. 2 is a flow diagram illustrating several methods 211 according to various embodiments of the invention. A method 211 may begin by communicating a data packet between two or more wireless networks across a peer-to-peer link, at block 223. The data packet may comprise a voice-over-internet-protocol (VoIP)-formatted packet, for example. The peer-to-peer link may comprise two or more distinct buses and may include a buffer, as previously mentioned. For more information on VoIP, please refer to International Telecommunication Union (ITU) Standard H.323—Version 5 “Packet-based Multimedia Communications Systems” (July 2003).

Method 211 may also include converting the data packet from a MAC format associated with a first of the two or more wireless networks to a MAC format associated with a second of the two or more wireless networks, at block 227. The conversion may be performed by a MAC conversion module associated with a baseband processing module, for example.

Method 211 may further include enabling a wireless mobile device to communicate with one or more of the two or more wireless networks at a time when a selected network is unavailable to the wireless mobile device, at block 231. As in the example previously provided, the wireless mobile device may comprise an IEEE 802.11 network-compliant laptop computer; and the selected network may comprise an IEEE 802.11 hotspot. Absent an available IEEE 802.11 hotspot, the laptop computer may communicate with a nearby IEEE 802.11-enabled cellular device. A data packet from the laptop computer may be forwarded by the cellular device to the Internet, across a cellular network. Thus, the method 211 may continue at block 233 with traversing one or more of the wireless networks to access the Internet from a wireless mobile device, wherein the device may not support connection to some of the networks traversed.

Method 211 may include bypassing a processor (e.g., an application processor and/or a graphics processor) associated with the wireless mobile device connected to the two or more wireless networks, at block 239. A data packet may bypass the processor, for example, when traversing the peer-to-peer link to communicate between the two or more wireless networks, thus conserving processor resources.

Method 211 may conclude with broadcasting the data packet to the two or more wireless networks, at block 257. It should be noted that the two or more wireless networks may, for example and without limitation, comprise a wireless local-area network (WLAN), a wireless wide-area network (WWAN), an IEEE 802.11 network, a GPRS network, and/or a WCDMA network.

It should be noted that the methods described herein do not have to be executed in the order described, or in any particular order. Moreover, various activities described with respect to the methods identified herein can be executed in repetitive, serial, or parallel fashion. Information, including parameter values, commands, operands, and other data, can be sent and received in the form of one or more carrier waves.

A software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment. Thus, other embodiments may be realized.

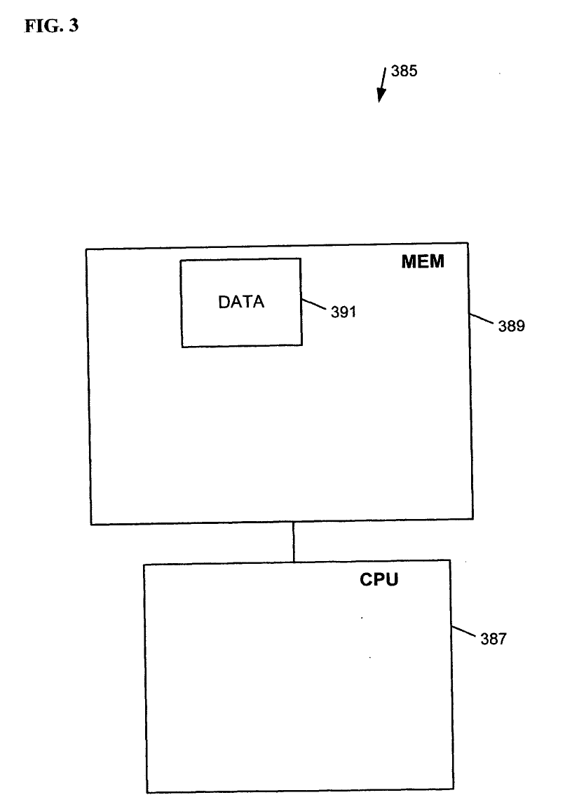

FIG. 3 is a block diagram of an article 385 according to various embodiments of the invention. Such embodiments may include a computer, a memory system, a magnetic or optical disk, some other storage device, and/or any type of electronic device or system. The article 385 may include one or more processors 387 coupled to a machine-accessible medium such as a memory 389 (e.g., a memory including an electrical, optical, or electromagnetic conductor) having associated information 391 (e.g., computer program instructions and/or data) which, when accessed, results in a machine (e.g., the one or more processors 387) performing such actions as communicating a data packet between two or more wireless networks across a peer-to-peer link. As previously mentioned, the peer-to-peer link may comprise a single bus, two or more distinct buses coupled by a hub, a switch, or both, or a buffer. The two or more wireless networks may comprise a WLAN and/or a WWAN. Other activities may include broadcasting the data packet to the two or more wireless networks.

Implementing the apparatus, systems, and methods disclosed herein may operate to enable communication between wireless networks employing incompatible physical layers, may permit access to a wireless network otherwise inaccessible to a mobile device at a particular place and time, and may decrease resource utilization associated with a mobile device processor.

Although the inventive concept may be described in the exemplary context of an 802.xx implementation (e.g., 802.11a, 802.11g, 802.11 HT, 802.16, etc.), the claims are not so limited. Embodiments of the present invention may well be implemented as part of any wired and/or wireless system Examples may also include embodiments comprising multi-carrier wireless communication channels (e.g., orthogonal frequency-division multiplexing (OFDM), discrete multi-tone modulation (DMT), etc.) such as may be used within a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS), and like communication systems, without limitation.

The accompanying drawings that form a part hereof show by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. An apparatus, including:
a peer-to-peer link to communicate at least one data packet between at least two wireless networks.

2. The apparatus of claim 1, further including:
a first wireless mobile device to connect to the peer-to-peer link to communicate with the at least two wireless networks.

3. The apparatus of claim 2, wherein the first wireless mobile device comprises at least one of a hand-held computer, a laptop computer, a personal digital assistant, and a cellular telephone.

4. The apparatus of claim 1, further including:
a first baseband processing module associated with a first media access control (MAC) format to communicate with a first one of the at least two wireless networks; and
a second baseband processing module associated with a second MAC format to communicate with a second one of the at least two wireless networks.

5. The apparatus of claim 4, wherein the first MAC format and the second MAC format are substantially identical.

6. The apparatus of claim 4, further including:
a MAC conversion module coupled to at least one of the first baseband processing module and the second baseband processing module to convert the first MAC format to the second MAC format.

7. The apparatus of claim 1, wherein one of the at least two wireless networks comprises at least one of an Institute of Electrical and Electronic Engineers (IEEE) 802.11 network, a general packet radio service (GPRS) network, and a wideband code-division multiple-access (WCDMA) network.

8. The apparatus of claim 1, wherein the peer-to-peer link comprises a buffer.

9. The apparatus of claim 8, wherein the buffer is capable of substantially simultaneous access by at least two devices.

10. The apparatus of claim 1, wherein the peer-to-peer link comprises a bus.

11. The apparatus of claim 1, wherein the peer-to-peer link comprises at least two distinct buses.

12. The apparatus of claim 11, further including:
at least one of a hub and a switch to couple together the at least two distinct buses.

13. A system, including:
a peer-to-peer link to connect to at least two wireless networks to communicate at least one data packet between the at least two wireless networks;
a first wireless mobile device to connect to the peer-to-peer link to communicate with the at least two wireless networks; and
an omnidirectional antenna coupled to the first wireless mobile device.

14. The system of claim 13, further including:
a second wireless mobile device to connect to the first wireless mobile device, to communicate with a first one of the at least two wireless networks across the peer-to-peer link.

15. The system of claim 14, wherein one of the wireless networks is unavailable to the second wireless mobile device.

16. The system of claim 14, wherein one of the wireless networks is not directly accessible by the second wireless mobile device.

17. A method, including:
communicating at least one data packet between at least two wireless networks across a peer-to-peer link.

18. The method of claim 17, further including:
bypassing a processor associated with a wireless mobile device connected to the at least two wireless networks.

19. The method of claim 18, wherein the processor comprises at least one of an application processor and a graphics processor.

20. The method of claim 17, further including:
enabling a wireless mobile device to communicate with one of the wireless networks at a time when a selected network is unavailable to the wireless mobile device.

21. The method of claim 20, wherein the wireless mobile device comprises an Institute of Electrical and Electronic Engineers (IEEE) 802.11 network-compliant laptop computer, and the selected network comprises an IEEE 802.11 hotspot.

22. The method of claim 17, further including:
traversing one of the wireless networks to access the Internet from a wireless mobile device, wherein the device does not support a connection to the one of the wireless networks.

23. The method of claim 22, wherein the one of the wireless networks comprises a cellular network and the wireless mobile device comprises a laptop computer.

24. The method of claim 17, further including:
converting the at least one data packet from a first media access control (MAC) format associated with a first one of the at least two wireless networks to a second MAC format associated with a second one of the at least two wireless networks, wherein the first MAC format comprises a format different from the second MAC format.

25. The method of claim 24, wherein converting the at least one data packet is performed by a MAC conversion module associated with at least one baseband processing module.

26. The method of claim 17, wherein one of the wireless networks comprises a selected one of an Institute of Electrical and Electronic Engineers (IEEE) 802.11 network, a general packet radio service (GPRS) network, and a wideband code-division multiple-access (WCDMA) network.

27. The method of claim 17, wherein the at least one data packet comprises a voice over internet protocol (VoIP)-formatted packet.

28. An article including a machine-accessible medium having associated information, wherein the information, when accessed, results in a machine performing:
communicating at least one data packet between at least two wireless networks across a peer-to-peer link.

29. The article of claim 28, wherein the information, when accessed, results in a machine performing:
broadcasting the at least one data packet to the at least two wireless networks.

30. The article of claim 28, wherein at least one of the at least two wireless networks comprises a selected one of a wireless local-area network (WLAN) and a wireless wide-area network (WWAN).
